(19) United States
(12) Patent Application Publication
(10) Pub. No.: US 2026/0195318 A1
(43) Pub. Date: Jul. 9, 2026

(54) TRUSTWORTHY EXTRACTIVE DECODING FOR GENERATIVE PROCESSES

(71) Applicant: Dell Products L.P., Round Rock, TX (US)

(72) Inventors: Werner Spolidoro Freund, Rio de Janeiro (BR); Marcus Vinicius Libardi Pazini, Caxias do Sul (BR); Herberth Birck Fröhlich, Florianópolis (BR)

(21) Appl. No.: 19/011,393

(22) Filed: Jan. 6, 2025

(51) Int. Cl. G06F 16/23; G06F 16/245

(52) U.S. Cl. CPC G06F 16/2365; G06F 16/245

(57) ABSTRACT

One example method includes receiving, such as by a virtual assistant for example, input from a user, such as a query, using the input to identify sources in a RAG (Retrieval Augmented Generation) database, selecting, from the sources, excerpts with information deemed responsive to the user input, performing an auto-regressive generation of trustworthy content, based on the information contained in the excerpts, post-processing the trustworthy content, and, returning the post-processed trustworthy content to the user.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to content generation. More particularly, at least some embodiments relate to systems, hardware, software, computer-readable media, and methods, for content generation in a RAG (Retrieval Augmented Generation) process.

### BACKGROUND

Retrieval Augmented Generation (RAG) has emerged as the de facto standard solution when developing systems that utilize Generative AI (GenAI) to break information silos and enhance the agility of navigating enterprise-level content. It provides an efficient approach to ground LLM responses with fresh or confidential information. In a first step of information retrieval, RAG obtains relevant information from indexed databases for a given user input, such as a query for example. A Large Language Model (LLM) then leverages user input and retrieved information as available in its prompt to provide an answer to the user during the content generation step. The answer is typically provided using autoregressive decoding, where each token is appended to the prompt until some condition is matched, for instance an end of sequence token is generated, or a maximum generated token length is reached.

The content generation step in a RAG system is typically an abstractive task, that is, content in the sources can be modified to filter relevant information from the sources, to rearrange such information, to perform any processing as required by the user, and to present the result in a user-friendly way. In many cases, business users using RAG systems to break information silos have shown to be mostly interested in extractive capabilities, where relevant and trustworthy information is provided nearly as-is to the user.

There are two main reasons for this. First, business content in many cases already contains the result of all reasoning available in the document themselves, therefore it mostly does not require further manipulation. Examples are competitive intelligence reports, strengths, and limitations of the products/services. Second, businesspeople are accountable for their choices and mostly prefer to perform reasoning for themselves than to rely on untrustworthy black-box mechanisms prone to errors of various natures that are often not of trivial detection, such as model hallucinations for example.

RAG systems often rely on basic decoding processes such as greedy or multinomial sampling approaches. In the former process, the highest likelihood token is selected at each step, whereas in the latter process, each token is sampled from a multinomial distribution using LLM logits outputs together with some additional parameters providing controls, for example, temperature, top_p, top_k, and repeating token penalty. Such decoding processes and other beam decoding variations do not constrain the generator from performing modifications in the source content as required in such applications. This hinders automated evaluation of system efficiency because it must be able to deal with valid semantic variations in the output. Additionally, such approaches do not provide a way to perform a deterministic link between the decoded information and the source, which hinders the user awareness of what information is trustworthy or not.

One approach to this problem relies on performing fully extractive tasks, where the language model is limited to selecting information from sources as is. While this provides a valid approach to filter and rearrange relevant information, it cannot perform any processing or connect trustworthy and grounded information in a user-friendly output.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an algorithm for constrained decoding with a completion engine.

FIG. 2 discloses aspects of an algorithm for a completion engine approach to evaluate whether a token sequence is valid.

FIG. 3 discloses usage of curated low entropy Q&A datasets for RAG system improvements, according to one embodiment.

FIG. 4 discloses aspects of a high-level process to generate and curate low entropy Q&A datasets, according to one embodiment.

FIG. 5 discloses aspects of a RAG system that employs extractive decoding.

FIG. 6 discloses dependencies between various algorithms, according to one embodiment.

FIG. 7 discloses an example of an extractive decoding algorithm computation of regular expressions constraining valid tokens, according to one embodiment.

FIG. 8 discloses aspects of an example auto-regressive prompt, according to one embodiment.

FIG. 9 discloses an example comparison of outputs when using two RAG systems operating identically, except for the decoding algorithm, according to one embodiment.

FIG. 10 discloses an example post-processing algorithm, according to one embodiment.

FIG. 11 discloses an example algorithm for automated assessment based on extractive decoding, according to one embodiment.

FIG. 12 discloses an example computing entity configured and operable to perform any of the disclosed methods, processes, and operations.

### DETAILED DESCRIPTION OF SOME EXAMPLE EMBODIMENTS

Embodiments disclosed herein generally relate to content generation. More particularly, at least some embodiments relate to systems, hardware, software, computer-readable media, and methods, for content generation in a RAG (Retrieval Augmented Generation) process.

One or more example embodiments comprise a method and/or architecture for content generation. An embodiment may be implemented in various applications, such as in connection with a virtual assistant, such as a chatbot for example, and may generate, and/or cause the generation of, new and/or modified content in response to a query posed by a user. The scope of this disclosure is not limited to application in chatbots however, and extends more generally to any application where a user, human or otherwise, makes a request for content. One example embodiment may comprise a modification to a content generation step of a RAG system and process.

One such method may comprise various operations, including: receiving input from a user; using the input to identify sources in a RAG database; selecting, from the sources, excerpts with information deemed responsive to the user input; performing, without use of an LLM, auto-regressive generation of trustworthy content, based on at least some of the excerpts; post-processing the trustworthy content; and, returning the post-processed trustworthy content to the user.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may generate trustworthy content responsive to a user inquiry. An embodiment may link the trustworthy content to originating sources. An embodiment may filter content to help ensure that a user receives only the most relevant information. An embodiment may generate trustworthy content that is responsive to a user inquiry, without requiring the use of an LLM (large language model). Various other advantages of one or more example embodiments will be apparent from this disclosure.

### A. References

Reference is made herein to various documents, listed below, each of which is incorporated herein in its respective entirety by this reference.
[1] Patrick Lewis, Ethan Perez, Aleksandra Piktus, Fabio Petroni, Vladimir Karpukhin, Naman Goyal, Heinrich Küttler, Mike Lewis, Wen-tau Yih, Tim Rocktäschel, Sebastian Riedel, Douwe Kiela, “Retrieval-Augmented Generation for Knowledge-Intensive NLP Tasks”, Apr. 12, 2021. https://arxiv.org/abs/2005.11401v4
[2] G. Poesia, K. Gandhi, E. Zelikman, and N. D. Goodman, “Certified Deductive Reasoning with Language Models.” arXiv, Nov. 7, 2023. Accessed: Apr. 3, 2024. [Online]. Available: http://arxiv.org/abs/2306.04031
[3] Y. Liu, “Fine-tune BERT for Extractive Summarization.” arXiv, Sep. 5, 2019. [Online]. Available: http://arxiv.org/abs/1903.10318
[4] U.S. patent application Ser. No. 18/962,092 , entitled “LOW ENTROPY APPROACH FOR ALIGNING GENERATIVE PROCESSES WITH HUMAN PREFERENCES”, filed Nov. 27, 2024.

### B. Aspects of an Example Context for One or More Embodiments

The following is a discussion of aspects of an example context for various embodiments. This discussion is not intended to limit the scope of the claims or this disclosure, or the applicability of the embodiments, in any way.

### B.1 Introduction

There are methods in literature dedicated to performing abstractive or extractive summarization that relate to this invention. There are important discrepancies, however. First, the discussion is limited to summarization tasks, whereas a method according to one example embodiment is suited for any task where RAG systems are employed, including but not limited to summarization. Further, abstractive and extractive summarization are concerned as mutually exclusive tasks. On the other hand, an embodiment comprises a way to merge the two worlds and continuously flow between abstractive or extractive decoding.

The inventors performed research of decoding methods in academic literature seeking a method capable of complying with our business requirements as described in Section 1. The nearest match is described in [2] where the authors claim to devise a guide tool responsible for constraining decoding methods to a set of valid generations given prior information. On the other hand, a method according to one example embodiment is built on top of such a concept. The authors of [2] describe and evaluate a tool dedicated to ground LLM deductive reasoning, which does not provide the capabilities disclosed herein. In the appendix of their work, the authors of [2] present simple descriptions of potential other guides for future work including a quote guide dedicated to ground answers similarly to ours. However, those authors do not provide any technical details on how their method is supposed to work.

By way of contrast, the present disclosure provides a complete solution to the problem of providing trustworthy outputs grounded on available sources. Such a solution also differs from conventional approaches, in one or more embodiments, by providing a mechanism to filter excerpts to be employed before composing the answer to reduce the influence of frivolous information in the decoding process.

### B.2 Discussion

### B.2.1 Retrieval Augmented Frameworks

Retrieval Augmented Generation (RAG) is a process by which a large language model (LLM) is fed with a query and with data that allegedly contains the answer to that query. The LLM is then constrained in such a way that its answer to the query should not deviate from the content given as input. RAG was proposed in [1] but lately its popularity has significantly increased and is now considered the state-of-the-art approach for achieving more reliable, up-to-date, and factual outputs from LLMs.

Current implementations of RAG typically break documents into chunks of raw text, that populate a set of databases that are then used as sources for question-and-answering. Those chunks are transformed into a vectorial representation, referred to as an embedding, with some language model and stored into a vector database, which indexes them efficiently. The language model used for embedding the chunks may be the same used to answer the user queries. Typically, however, a lighter model with fewer parameters is employed. The chunks are stored with metadata indicating the original source document. Additionally, other metadata may be associated with the chunks, such as authorship and other characteristics, which may be stored in the vector database or elsewhere, in structured or unstructured format.

When the user submits a query to the LLM, that query is first embedded with the same language model used to embed the document chunks. The embedded query is then used to search the most similar chunks in the vector database, using the embedded chunk vectors. Similarity in the vector space is typically computed with some distance function such as the Euclidean distance, or cosine distance. This process is referred to as semantic search because the embeddings encode some semantics of the input sentences.

From the top-k most similar chunks, the associated documents, and any additional metadata, are retrieved. Those, in turn, will be used to assemble the input, also known as context, prompt or linguistic instruction, for the LLM. Typically, the input follows a template having some natural language instruction for the LLM, the query to be answered, and the document contents to be summarized.

RAG implementations usually vary in the choice of the language model for the embeddings, the chunking strategy used for source documents, the types of metadata associated with the chunks, how the documents associated with the chunks are accessed and processed, how the LLM input is assembled, and in the choice of the LLM itself.

### B.2.2 Autoregressive Decoding

Several approaches have been previously studied in the literature regarding how to autoregressively generate a sequence of outputs that best suits a given task. Autoregressive generation is the process of sampling outputs from a model and concatenating it to the previous input sequence to generate the next output. The process continues until some condition is matched, for instance a special value is output by the model (as an end of sequence) or an arbitrary number of tokens is generated. In Natural Language Processing (NLP) tasks, some decoding approaches are available, such as:
Greedy decoding: the sampling process chooses the most probable model output, that is, by picking the argmax token of the log probabilities as estimated by the softmax layer of the LLM. This results in the generation of deterministic outputs and is a special case of multinomial decoding where temperature is set to 0.
Multinomial decoding: the sampling process uses model log probabilities to compose a multinomial function to dictate the likelihood of a token to be used as the next token. Additional parameters are used to control the sampling behavior, for instance:
   Temperature: provides a way to control the multinomial distribution entropy, with lower values resulting in lower entropy, that is, a more concentrated distribution, therefore closer to a deterministic sampling.
   Top_p and top_k: are truncation parameters, to mitigate unexpected abruptions due to sampling of tokens in long tails, therefore breaking manifolds in the output space.
   Repetition penalties: are used to make output more fluid by reducing the probability of repeating a token.
Beam search: previous decoding strategies scan an output space only once, therefore being a computationally cheap decoding algorithm. However, the decoding problem is often represented as the challenge of maximizing the joint probability of the output sequence as predicted by the generative model. The optional length-T sequence in this setting is a Maximum A posteriori Probability (MAP) inference on a T-order Markov chain with nodes composed of model output at each time step. Beam search is an algorithm to perform such search, where a set of B output sequences are kept. At each time step, each beam is completed with all token extensions and only the most likely are kept for the next step. At the end of the process, B sequences and their ranking are made available, where typically the one with highest likelihood is returned.
   Beam search variations: alternatives to the beam search algorithm are available. One approach is the diverse beam search which introduces heuristics in the search process to incorporate diversity across beam groups by using a dissimilarity function—in practice, typically hamming diversity is employed by computing the total number of shared equal tokens among groups.

### B.2.2.1 Constrained Decoding

Various algorithms can be used to perform constrained decoding, each case applying modifications to decoding algorithms so that restrictions are satisfied. In many cases, the problem is cast on top of performing MAP inference on Markov chain constrained that some conditions are satisfied. For instance, algorithms may require that some token sequences are present or not present in the generated output sequence. The GridSearch algorithm builds on top of beam search decoding and introduces heuristics to constrain decoding whenever a token available in the restriction is generated, forcing the decoding to follow paths specified in the constraints. Some modifications shift token distributions to increase or reduce the probability of semantically related tokens to be generated until conditions are matched, therefore increasing the likelihood of the beam search algorithm to trail sequences of interest.

### B.2.2.1.1 Guided Decoding

One or more embodiments comprise a type of constrained decoding where guide tools are employed. Certified Deductive Reasoning [2] purports to provide a way to employ dynamic constraint rules based on pre-defined conditions. Formally, let S=Σ* be the set of strings in the guide alphabet Σ, with S* denoting the set of finite sequences of such strings. Then the guide is a function g: S\hat{ }*→P(S; . . . ) that builds upon the sequence of previously generated strings as input and priorly defined information, such as source and excerpts, in one embodiment, to return a regular set of allowed next generations. In one or more embodiments, this definition may be used to guide a decoding process.

The reference [2] describes the general workflow of constrained decoding using a completion engine. Functions such as constraint_stream.can_token_follow() and constraint_stream.get_valid_tokens() call a completion engine as described in an Algorithm 2, addressed below. The completion engine is an approach that may enable constraints to be implemented upon common tools such as regular expressions (regexp). Thus, regular expressions are provided by the guide tool at each autoregressive step to determine whether a token is valid. It incrementally evaluates token generations to check whether they are valid using regexp. Whenever a violation is observed, the vocabulary is checked against the current completion position to determine the next valid tokens. The completion then continues by sampling from those valid tokens.

The guide tool and completion engine discussed above may serve as foundations for one or more example embodiments. One embodiment of a guide tool to perform trustworthy extractive decoding is disclosed elsewhere herein. It is noted, however, that embodiments are not limited to deriving a guide tool on top of a completion engine. Rather, such an approach is provided only by way of illustration, and may be employed to facilitate development of a particular embodiment.

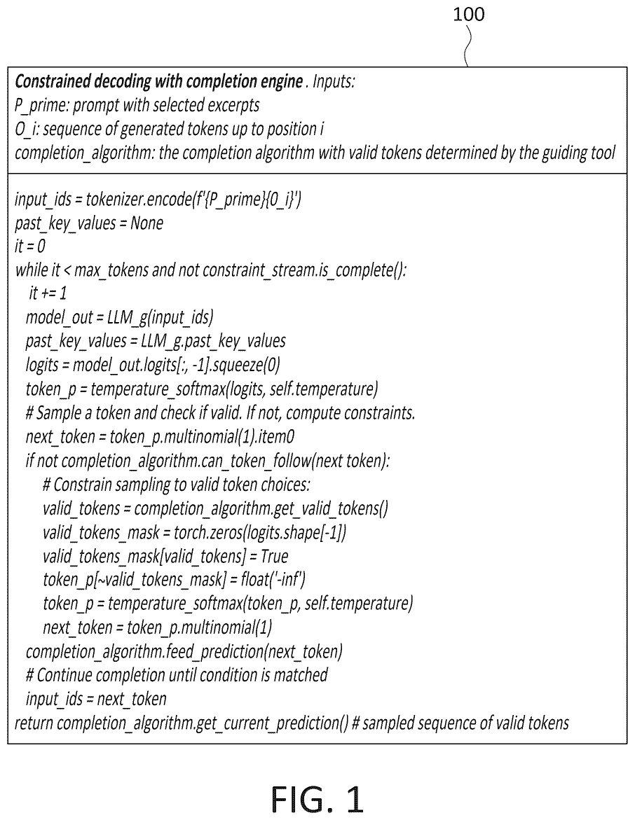

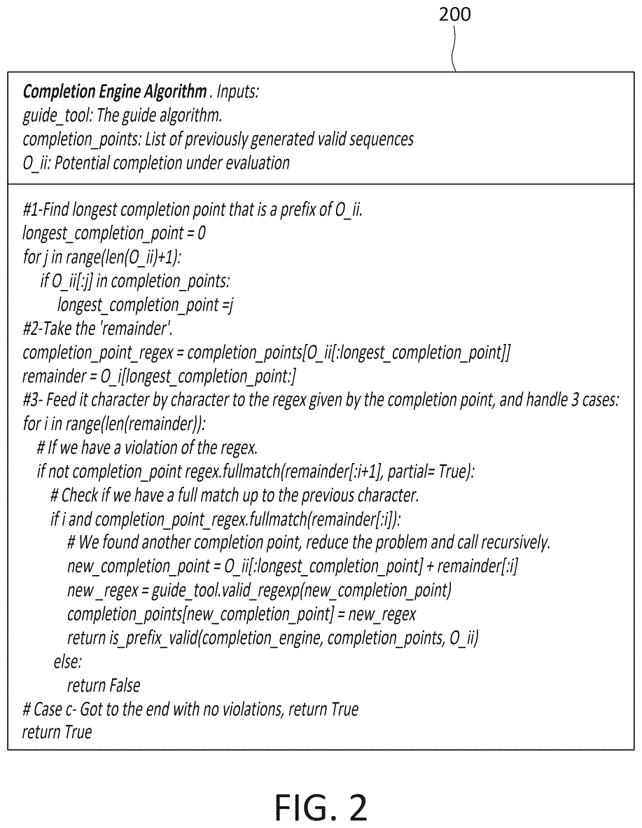

With reference now to FIGS. 1 and 2, some example algorithms such as may comprise elements of one or more embodiments are disclosed. In particular, FIG. 1 discloses an algorithm 100—which may also be referred to herein as ‘Algorithm 1’—for constrained decoding with a completion engine. An embodiment of the algorithm 100 may be adapted from [2]. FIG. 2 discloses an algorithm 200—which may also be referred to herein as ‘Algorithm 2’—for a completion engine. In more detail, FIG. 2 discloses a completion engine approach to evaluate whether a token sequence is valid. This is evaluated in Algorithm 1 when can_token_follow or get_valid_tokens are executed. An embodiment of the algorithm 200 may be adapted from [2].

### B.2.3 Abstractive, Versus Extractive, Tasks

One or more example embodiments broadly relate to the concept of abstractive and extractive summarization. In extractive summarization, a model is set to select excerpts from the document in order to compose the summary. The excerpts are provided as available in the original sources, so the summary is ensured to be composed of trustworthy information, provided the original sources are correct, in the sense that the model cannot introduce content variations in the output. One approach, see [3], fine-tunes BERT together with other modifications to classify whether sentences are to be part of the summary or not.

On the other hand, abstractive summarization aims at transforming text in order to achieve a more synthetized description of the document. LLMs may excel in abstractive summarization. Generalizing beyond summarization, extractive tasks are constrained to return the content as-is without modification, limited to only filtering and/or sorting content, whereas abstractive tasks can benefit from content transformations aiming at making the resulting representation more efficient as required by the task.

One or more embodiments may thus comprise a way to connect the two worlds, that is, the abstractive approach and the extractive approach, in such a way that the model dynamically flows between abstractive and extractive decoding based on its own decisions. This provides the benefit of the best of each of these two worlds, namely, to transform the content such that it is displayed in a format as instructed by the user, while also knowing when the output is trustworthy and grounded by a source retrieved by the RAG system.

### B.2.4 Low Entropy Q&A Dataset

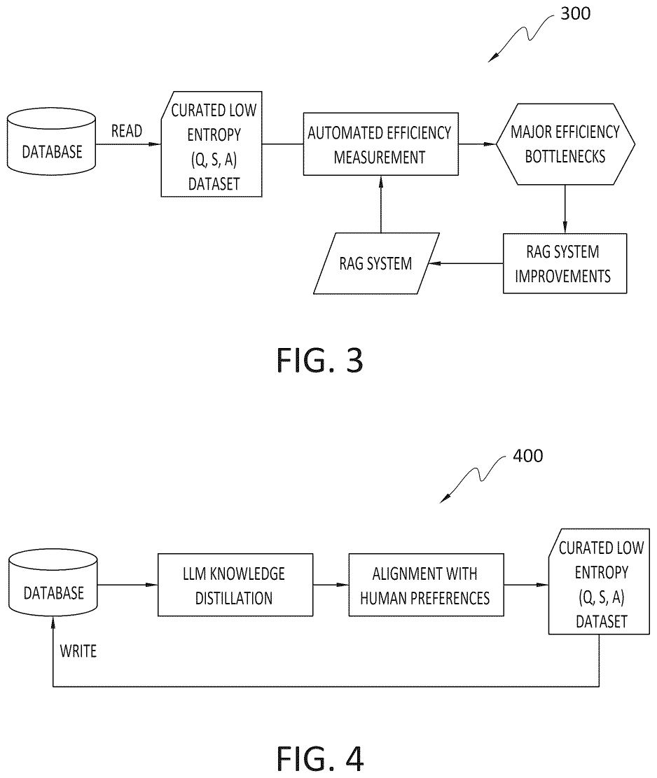

The reference [4] discloses a method, denoted at 300 in FIG. 3, to work around LLM usage for automated alignment with human preferences and efficiency measurement of RAG systems by relying on the synthetic generation and curation of a low entropy question, source, answer (Q, S, A) dataset. Particularly, the method 300 involves usage of curated low entropy Q&A datasets for RAG system improvements. The generation and curation of low entropy Q, S, A datasets occur by feeding document passages in a dataset to an LLM to generate question/input and answer/output (Q&A) pairs, as indicated by the method 400 disclosed in FIG. 4. Particularly, FIG. 4 discloses a method 400 comprising a high-level process to generate and curate low entropy Q&A datasets. These Q&A pairs have special properties that allow straightforward alignment with human preferences and efficient evaluation without relying on LLMs, as described hereafter.

The curated low entropy Q, S, A dataset may be an important resource. Its generation and curation occur on the following concepts that allow automated verification to occur efficiently without LLMs: (1) the distillation of LLM knowledge onto Referenced Patterns of Information (RPIs); and (2) the introduction of squashing instructions (SQIs) to questions/inputs.

RPIs can be directly modified to collect human feedback, avoiding LLM systematic behavior during automated evaluation while guiding system towards human preferences. This means that human feedback can be collected only once, during dataset generation, and with lower strains on users by benefitting of the LLM distillated knowledge. However, the LLM knowledge distillation process results in one RPI per information aspect. A single RPI may not be able to capture eventual semantic variations in an unconstrained decoding, resulting in automated evaluation efficiency gaps.

Thus, an embodiment may address limitations in automatic evaluation based on RPIs to avoid systematic errors in efficiency measurement. Particularly, an embodiment may automatically derive variational RPIs, and may perform inconsistency checks.

### C. Overview of Aspects of One or More Embodiments

### C.1 Introduction

One or more embodiments comprise an approach for enabling content generation to continuously flow between abstractive and extractive decoding while solving various problems through: (1) limiting output variations when the content generation is expected to be grounded by guiding the decoding process to extract information as available in the sources while, at the same time, providing freedom for it to generate and manipulate content whenever required so that the answer is provided in a friendly format, that is, as in human feedback; (2) providing deterministic links between the answer and the sources so that the user can be aware of when the information is trustworthy and grounded by a source; and (3) ensuring that efficient automatic evaluation of system output can take place without relying on black-box mechanisms to handle output semantic variations, which can introduce systematic effects in the evaluation process. By efficient, it is meant that automatic evaluation rewards and penalizes the system as in manual analysis.

### C.2 Discussion

An embodiment comprises a method for modifying a content generation step in RAG systems to ensure that: (1) the end user of the content is made aware of what information in the RAG system output is trustworthy and grounded, what is the underlying information source and where the information is located in the source, if metadata is kept during RAG system injection pipeline)—this output may be provided in an efficient and user-friendly format; and (2) that the content can be efficiently evaluated using, for example, a simple pattern matching approach to determine whether the system is behaving correctly or not, given certain Q&A datasets.

In an embodiment, a modified content generation process of a RAG system may comprise operations including:
1. The user input, such as a user query to a chatbot for example, is used by a retrieval mechanism to obtain sources, in RAG database(s), responsive to the user input.
2. Excerpts with information deemed important to compose the output are selected from the sources:
   a. Each excerpt is unique and is accompanied by an identifier.
   b. To mitigate frivolous or noisy information, a new prompt is built on top of the excerpts instead of sources.
3. Auto-regressive generation is performed:
   a. It is based on at least two decoding strategies:
      i. abstractive decoding (a standard decoding method) and
      ii. extractive decoding (dedicated to ground generated content to excerpts, resulting in trustworthy outputs).
   b. The LLM model automatically switches the decoding strategy by generating a special sequence of tokens. This requires the LLM to be statistically pressured so that it can switch. In one embodiment, in-context few-shot learning is adequate.
   c. During abstractive decoding, that is, standard operation, any method can be employed.
   d. During extractive decoding:
      i. The extractive sequence of text is generated by constraining the next tokens to all valid tokens to the right of the sequence of text generated so far added of the token sequence to return to abstractive decoding.
      ii. For example, suppose that a selected excerpt contains [[excerpt: happy_montalcini: “Up to 1 TB PCIe NVMe SED Class 40 Up to 2 TB PCIe NVME SSD Class 40”]] and the model has generated the extractive sequence <[[cite_excerpt: happy_montalcini: “Up to >so far. In this case, the valid tokens are included within the set {1,2,”]]}, either to respectively potentially generate 1 TB, 2 TB or to finish extractive decoding at this stage.
      iii. If no token has been generated so far, then all tokens within excerpts (or within a selected excerpt, depending on the embodiment) are valid.
      iv. This approach is adequate to ensure that the generated content during extractive decoding:
         1. is grounded; and
         2. can be deterministically linked to the corresponding excerpt that it is grounded to and, therefore, to the corresponding source.
4. A post-processing step can take place, in one embodiment, to improve the final output sequence.

Experiments conducted by the inventors on applications focusing on breaking information silos show that an approach according to one embodiment effectively provides a way to inform the user when the answer is grounded, and to deterministically link content of the answer to the corresponding source. One example embodiment comprises use of this approach together with low entropy efficiency measurements disclosed in [2], to obtain an approach to automatically measure RAG system output quality with perfect alignment to manual evaluation. It is noted that this approach, and others disclosed herein, do not rely on black-box mechanisms such as LLMs and, as such, one or more embodiments may control, and avoid, systematic errors during efficiency measurement.

### C.3 Further Discussion

As disclosed herein, one or more embodiments may possess various useful features and aspects, although no embodiment is required to possess any of such features or aspects. The following examples are illustrative but not exhaustive.

A RAG system according to one embodiment may generate content and automatically determine, during and/or as part of auto-regressive decoding, when to generate trustworthy content that is grounded on source excerpts. A RAG system according to one embodiment may provide a deterministic link of the grounded content to the originating excerpt and/or corresponding source, so as to deterministically ensure to the final user what information is trustworthy or not and what is the underlying source of that information. A RAG system according to one embodiment may filter useful excerpts to be employed during the content generation step and therefore reduces the influence of frivolous information in the decoding process. A RAG system according to one embodiment may be used to provide an automated efficiency measurement approach that matches human evaluations and that does not rely on LLMs.

### D. Detailed Description of Aspects of One or More Embodiments

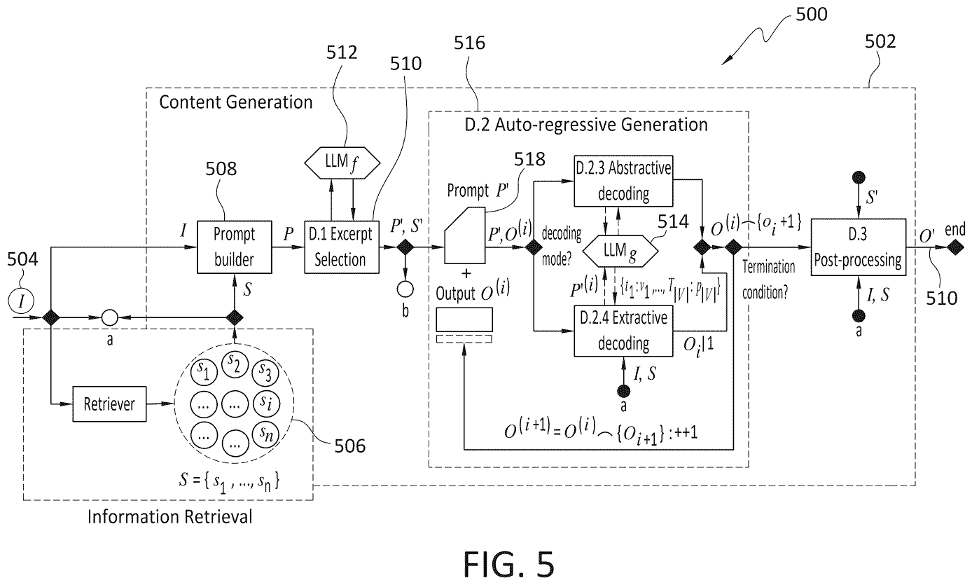

With attention now to FIG. 5, a RAG system 500 according to one embodiment is disclosed. The RAG system 500 can flow between performance of abstractive tasks and extractive tasks by dynamically adjusting the decoding approach during auto-regressive generation. By proceeding this way, the RAG system 500 comprises an approach that may: (1) ensure that the RAG system 500 outputs factual information whenever it operates on extractive decoding, therefore mitigating error sources; (2) enable final users to have knowledge of when the system output is trustworthy and grounded on a source; and (3) automatically evaluate the RAG system 500 performance without relying on untrustworthy black-box mechanisms when used together with the low entropy quality framework.

With more particular reference now to FIG. 5, that Figure discloses a high-level operation of a RAG system 500 employing extractive decoding. In FIG. 5, the symbol [symbol] denotes set concatenation as performed in auto-regressive generation. The components in the content generation section 502 include reference numbers that correspond to the discussion below.

As depicted in FIG. 5, the RAG system 500 may being operating with an input I 504, such as a user query for example, retrieves sources S 506 and builds a prompt P 508. In an embodiment, the RAG system 500 is independent and can benefit from the use of any system and/or method to retrieve sources 506 and build the content generation prompt 508. The only restriction is that content generation section 502 has access to I and S. The remainder of this section describes modifications in the content generation section 502 so that the system outputs O′ 510 with the aforementioned properties.

### D.1 Excerpt Selection

The inventors have observed in business data that output generation can be subject to additional error rates if the required relevant content is provided together with considerable frivolous or noisy information. Thus, inspired by prompt engineering techniques, such as chain of thought and variations, and agentic frameworks, an embodiment of excerpt selection 510 may reduce the complexity of output generation task by first requiring this task to filter excerpts from the sources. This results in a fully extractive task on top of sources S 506, thus not requiring the ability to flow between abstractive and extractive decoding. As a result, excerpt selection can be performed separately or jointly to auto-regressive generation step.

Regardless of the approach employed, one embodiment may require that each excerpt is unique and does not overlap, in terms of its content at least, with any other excerpt:
Unique excerpts can be achieved by simply ignoring duplications:
   Each excerpt is accompanied by an identifier. This invention does not require any specific identifier form, our exemplary embodiment employed random names to avoid potential sequential token bias. The inventors determined that the identifier may influence extractive decoding such that some embodiments can lead to better results than others but did not perform yet any optimizations in this regard.
A simple approach to ensure that excerpts do not overlap can be achieved by masking extracted excerpts in the sources with a marker and constraining the selection method from extracting masked text. On embodiment may use |extracted_excerpt, but a randomly generated marker not available in the source can be used to avoid conflicts with source content.

If excerpt selection 510 is performed separately from auto-regressive generation, then it can benefit from the use of a dedicated model, such as LLM_{f} 512 in FIG. 5. In an embodiment, this dedicated model may be composed of a task-specific model trained exclusively to perform text extraction. An example of how to fine-tune language models to perform extractive tasks is referred to elsewhere herein.

Otherwise, the excerpt selection 510 employs the general-purpose model used for auto-regressive content generation 516, indicated as LLM_{g} 514 in FIG. 5, but always operating with extractive decoding instead of automatically selecting the decoding method. This can be achieved by constraining LLM_{g} 514 to either terminate generation, or to immediately reenter extractive generation, whenever it completes the extraction of an excerpt. A simple way of doing this is by introducing another guide that operates whenever extractive guide is not active that restricts generation to either the special sequence of tokens or terminate generation.

It is noted that, in an embodiment, the availability of such excerpts provides a way to facilitate collecting human feedback such that if an answer is wrong, users can remove or add excerpts to correct the output. After excerpt selection 510, a new prompt P′ 518 may be built on top of the filtered excerpts to minimize any impact of frivolous or noisy information in the auto-regressive content generation. Depending on the strategy employed, the prompt P′ 518 may operate to exert statistical pressure or influence within LLM_{g} 514 such that a proper output is generated.

### D.2 Autoregressive Generation

It is noted that an introduction is provided above at part B.2.2 for auto-regressive generation, indicated at 516 in the example of FIG. 5. Further details are provided below.

### D.2.1 Model Selection of the Decoding Method

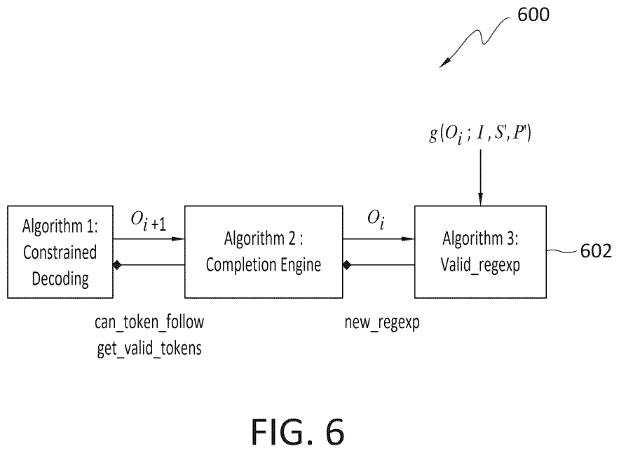

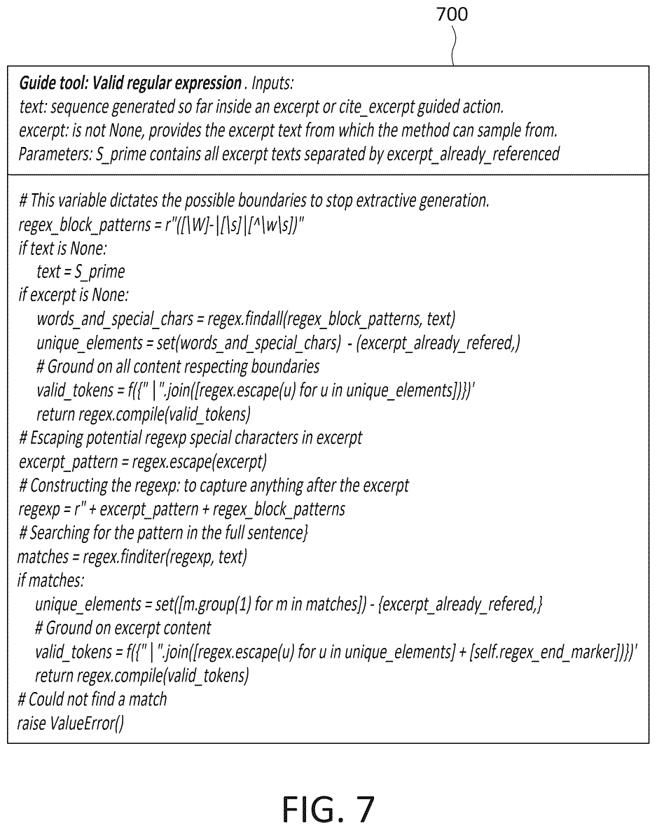

A method according to one embodiment enables auto-regressive generation to automatically flow between abstractive and extractive decoding as determined by LLM_{g} 514. The autoregressive generation loop is executed in the main loop from Algorithm 1 discussed above. The example schema 600 of FIG. 6 depicts some dependencies between algorithms, such as ‘Algorithm 1’ and ‘Algorithm 2,’ that may be employed in one or more embodiments. The algorithm 602, which may also be referred to herein as ‘Algorithm 3’ (also denoted at 700 in FIG. 7), is discussed below. In an embodiment, the flow between decoding methods occurs through the generation of special delimiters t₁ and t₂. These form the rules of communication between the LLM_{g} 514 and the guide tool. Such rules must be established and shared by LLM_{g} 514 and g before auto-regressive decoding starts. Just like excerpt identifiers, these must be defined with a focus on avoiding conflicts with content available in the documents. In one example embodiment, t₁=[[and t₂=″]] similar to the approach in [2], except for the quote in t₂ which may be added for speculative purposes.

During most operations, in one embodiment, constrained decoding algorithm and the completion engine sample from abstractive decoding and evaluates whether t₁ has been generated. It simply continues auto-regressive generation until t₁ is observed. This is because g(Oᵢ) outputs a regexp that accepts all token sequences until t₁ is generated. In such cases, auto-regressive generation switches from abstractive to extractive decoding and more restrictive regular expressions are returned to the completion engine.

### D.2.2 Statistical Pressure

In an embodiment, the model must be statistically pressured to perform correct token choices and, thus, appropriate usage of the guide decoding function. This may be required because most pre-training data does not pressure LLMs to generate such a special sequence of tokens when quoting prior content. Here, it is noted that:
1. In experiments conducted by the inventors, in-context few-shot learning is enough to efficiently pressure LLM_{g} 514 to modify its own decoding algorithm (from abstractive to extractive and vice-versa).
2. However, LLM_{g} 514 can also be fine-tuned in addition to or to replace in-context few-shot learning.
   In this way, one can avoid pre-training a foundational model, or inserting new special tokens in the vocabulary. Thus, an embodiment of the method can work with any general-purpose LLM.

### D.2.3 Abstractive Decoding

In an embodiment, abstractive decoding serves to perform transformations in the content such that the output is provided in a way that is aligned with human preferences. An embodiment of a method does not require any specific property when performing abstractive decoding, except that the model must be able to generate the special identifiers described above in the section on model selection of the decoding method. Examples of potential methods are described earlier herein, including constrained decoding and other guides.

It is noted that, in an embodiment, some decoding strategies can result in better final output sequences than others. Particularly, introducing modifications to diverse beam search heuristics can lead to better exploration of the output space while mitigating the impacts of guided decoding. One example embodiment may use a greedy abstractive decoding process.

### D.2.4 Extractive Decoding

In one embodiment, extractive decoding may be achieved through a specially tailored guide tool. In an embodiment, g has a minimal parametric form of g(.;S′), where S′ is used internally within ‘Algorithm 3’ 700 (FIG. 7) to constrain generation. As depicted in FIG. 6, g is used to guide auto-regressive generation to obey pre-defined rules. These rules specify the formatting of generated sequence. Guide tool formatting should be aligned with specifications employed in prompt content and/or fine-tuning data so that statistical pressure is enforced. This includes the formatting of selected excerpts using the algorithm discussed above in the section on excerpt selection. One embodiment uses the following formats—it is noted that both formats can be adjusted to improve performance or to better suit application requirements:
[[excerpt:#id:“#value”]] when the generator is used to filter excerpts from sources S. In this case, “excerpt” is a hard-coded string that is added whenever t₁ is generated during execution of the excerpt selection stage. Here, <#id> and <#value> are placeholders, where <#id> is obtained programmatically and <#value> is sampled using ‘Algorithm 3’ 700 without specifying excerpt argument.
[[cite_excerpt:#id:“#sub_value”]] when the generator is operating in autoregressive generation. In this case, #id must be sampled by the generator from the available excerpt ids. Once the excerpt id is determined, it performs sampling from tokens available in such excerpt using Algorithm 3 with #value from the sampled excerpt id. An alternative embodiment may format #id after #sub_value. In such a case, ‘Algorithm 3’ 700 is employed without providing excerpt text and <#id> is defined programmatically.

In one embodiment, the extractive decoding ensures that #value and #sub_values generated are grounded respectively to sources and excerpts. To achieve such behavior, the extractive sequence of text is generated by constraining next tokens to the set of t2, and all valid tokens to the right of the sequence of text generated so far, added.
1. For instance, suppose that a selected excerpt contains [[excerpt: happy_montalcini: “p to 1 TB PCIe NVMe SED Class 40 Up to 2 TB PCIe NVME SSD Class 40”]] and the model has generated the extractive sequence <[[cite_excerpt: happy_montalcini:“p to >so far. In this case, the valid tokens are included within the set {1,2,”]]}, either to respectively generate 1, 2 or to exit extractive decoding.
2. If no token has been generated so far, then all tokens within the chosen excerpt (or all excerpts) are valid.
   A more complete description of the extractive decoding algorithm computation of regular expressions constraining valid tokens is indicated in ‘Algorithm 3’ 700.

It is noted that, in an embodiment, the unique identifiers may be used to provide a deterministic link to the corresponding excerpt that it is grounded to. The link can continue to the source by simply using a dictionary mapping from excerpt keys to source keys. As in standard autoregressive generation, the process is completed when some termination condition is matched, resulting in the generation of an output sequence O⁽ⁱ⁾.

### D.3 Post-Processing

Finally, the output sequence may, in one embodiment, be post-processed to improve the final user experience, that is, the quality and relevance of the information provided to the user. Multiple post-processing strategies may be employed, separately, or at once. Such post-processing strategies include, but are not limited to:
1. Applying cosmetic fixes in generator output, such as evaluate and extend extraction boundaries to become as extensive as possible.
2. Modifying output to be displayed in a user-friendly format.
3. Modifying output so that it can be employed for automated evaluation.
4. Evaluation of ethical and other requirements, such as pertaining to the information to be provided to the user.
   Post-processing may be implemented using a variety of available tools. Some examples of different post-processing approaches are discussed below.

### E. Examples

### E.1 Auto-Regressive Prompt

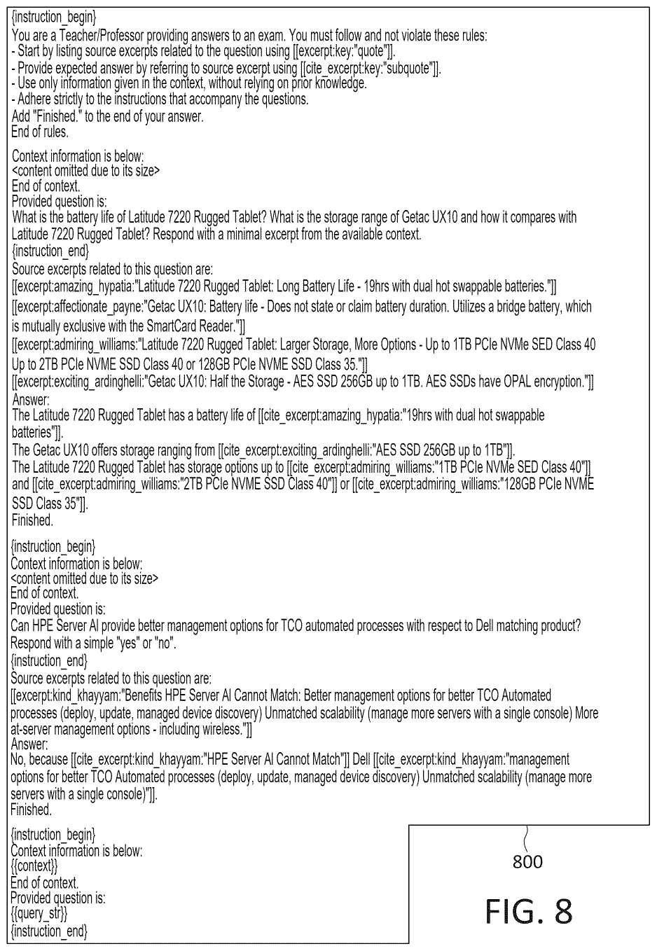

With reference now to FIG. 8, an example algorithm 800 for an auto-regressive prompt is disclosed. This auto-regressive prompt provides an example of how a general-purpose LLM can be pressured towards using extractive selection. During auto-regressive generation, the RAG system will capture the selected excerpts. These excerpts are then employed whenever the model enters extractive decoding, thus ensuring grounded outputs. It is noted that experiments performed by the invenors used mistralAi/Mistral-7B-Instruct-v0.2 on top of a transformers library.

### E.2 Example Comparing Decoding Strategies

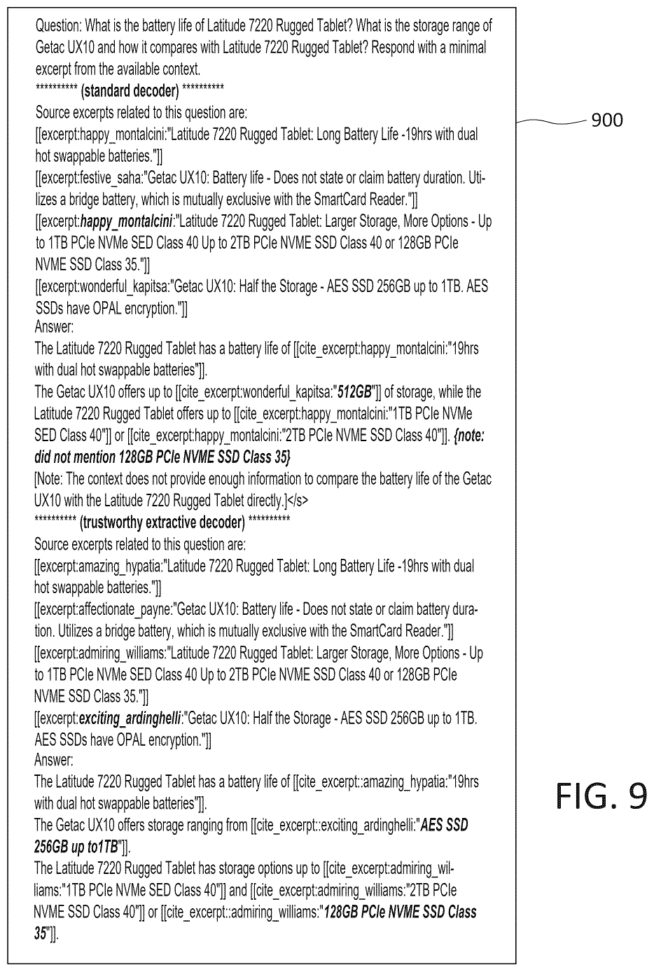

With reference now to FIG. 9, an example algorithm 900 for an approach to compare decoding strategies is disclosed. In the example of FIG. 9, an embodiment compares the outputs when using two RAG systems operating identically, except for the decoding algorithm. First is shown the output when standard greedy decoding is employed. Although LLMg can follow the specified format and efficiently extract correctly many excerpts and some citations correctly, it introduces untrustworthy information (indicated in bold/italic in FIG. 9: ‘happy_montaleini,’ ‘512 GB,’ and ‘{note: did not mention 128 GB PCIe NVME SSD Class 35}’) as being part of the source. See, for example, the citation of ‘512 GB’ in excerpt with ID ‘wonderful_kaptsa,’ which does not contain such information. This does not occur when trustworthy extractive decoding is performed by an embodiment.

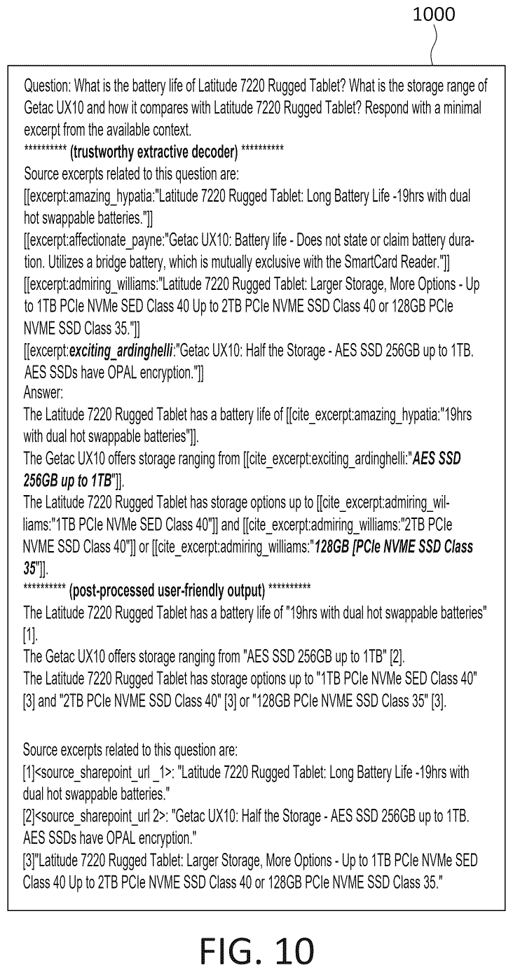

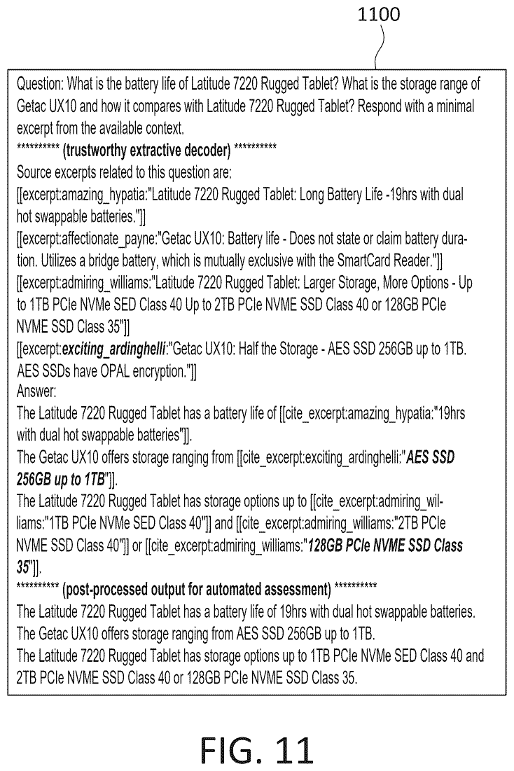

As also indicated in FIG. 9 (in bold/italic highlight: ‘exciting_ardinghelli,’ ‘AES SSD 256 GB up to 1 TB,’ and ‘128 GB PCIe NVME SSD Class 35’), an approach according to one embodiment efficiently removes all error sources in this example while ensuring that cited information—that is, the bold/italic highlighted items just mentioned (and also included in FIGS. 10 and 11)—is correctly grounded on selected excerpts.

### E.3 User-Friendly Trustworthy Extractive Decoding

Turning next to FIG. 10, an example algorithm 1000 for user-friendly trustworthy extractive decoding is disclosed. For the same example discussed in the section on example comparing decoding strategies, an embodiment comprises a potential post-processing to provide a better user experience. One potential approach to implement this post-processing could leverage on LMQL library. If benefitting of a user interface, an embodiment may implement a routine to expand to the source content on mouse hover.

### E.4 Automated Assessment Based on Extractive Decoding

With reference now to FIG. 11, an example algorithm 1100 for automated assessment based on extractive decoding is disclosed. It is noted that other post-processing can be used depending on the final use case. For example, when evaluating output quality with low entropy framework, it may be useful to remove all decorations to avoid impacting assessment.

### F. Experiments and Results

In one experiment, the inventors derived a low-entropy dataset on top of 32 competitive intelligence documents (58 slides) with 91 curated Q, S, A triplets. The samples have been curated by researchers (not final users) to test the system capabilities to align with their preferences. It is noted that since the tasks are mostly extractive, the curation process is not expected to be far from final user preferences. From these 91 triplets:
58 triplets use general-purpose instructions dedicated to relevancy aspect, that is, respond with an excerpt of the available context.
The remaining 33 triplets cover answer polarity aspect (respond with a simple ‘yes’ or ‘no’) on top of inputs consulting information as provided in the documents, where 19 require affirmative answers and 14 negative answers. For these questions, the model has been requested to provide an explanation for its polarity decision.

This example dataset was used to verify the efficiency of two RAG systems which were identical except for their decoding mechanisms: one relying on standard greedy decoding; and the other using an embodiment of the trustworthy extractive decoding algorithm disclosed herein. Based on this evaluation, the following insights have been derived:
There was virtually no automated evaluation efficiency gap: the inventors observed that automated evaluation perfectly matched human evaluation. This means that for use cases where trustworthy extractive decoding is needed, the inventors have derived an approach to achieve fully automated evaluation without discrepancies with respect to human evaluation and that does not leverage on black-box models that may be untrustworthy.
Space for further optimization: when using trustworthy extractive decoding, the inventors observed a loss of 10 p.p. with respect to standard decoding, which can be a reasonable price to benefit trustworthy outputs in many scenarios. However, the trustworthy extractive approach did not benefit any prompt engineering effort.

### G. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### H. Further Example Embodiments

Following are some further example embodiments. These are presented only by way of example and are not intended to limit the scope of this disclosure or the claims in any way.
Embodiment 1. A method, comprising: receiving input from a user; using the input to identify sources in a RAG (Retrieval Augmented Generation) database; selecting, from the sources, excerpts with information deemed responsive to the user input; performing auto-regressive generation of trustworthy content, based on at least some of the excerpts; post-processing the trustworthy content; and, returning the post-processed trustworthy content to the user.
Embodiment 2. The method as recited in any preceding embodiment, wherein each of the excerpts is unique and does not overlap, in terms of content, with any of the other excerpts.
Embodiment 3. The method as recited in any preceding embodiment, wherein selection of the excerpts is performed using an LLM (large language model).
Embodiment 4. The method as recited in any preceding embodiment, wherein the auto-regressive generation comprises performing extractive decoding, and abstractive decoding, on information in the excerpts.
Embodiment 5. The method as recited in any preceding embodiment, wherein the excerpt selection is performed using a content generation prompt that is built based on the input received from the user and on information about the sources.
Embodiment 6. The method as recited in any preceding embodiment, wherein the auto-regressive generation is performed using an LLM (large language model).
Embodiment 7. The method as recited in any preceding embodiment, wherein the auto-regressive generation comprises switching between extractive decoding, and abstractive decoding, of information in the excerpts.
Embodiment 8. The method as recited in any preceding embodiment, wherein the input from the user comprises a query.
Embodiment 9. The method as recited in any preceding embodiment, wherein the post-processed trustworthy content is returned to the user by a virtual assistant.
Embodiment 10. The method as recited in any preceding embodiment, wherein a deterministic link connects the information with the sources.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

### I. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

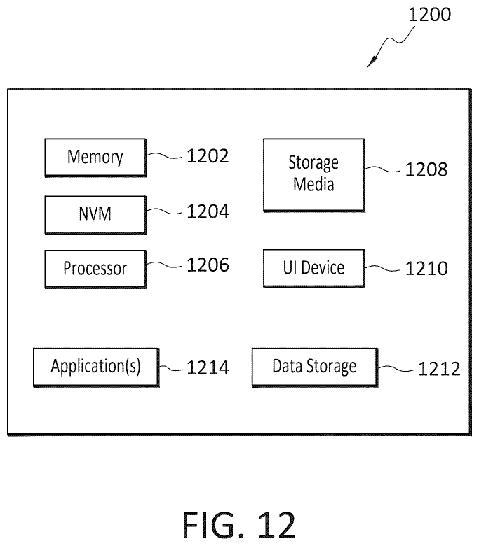

With reference briefly now to FIG. 12, any one or more of the entities disclosed, or implied, by FIGS. 1-11, and/or elsewhere herein, may take the form of, or include, or be implemented on, or hosted by, a physical computing device, one example of which is denoted at 1200. As well, where any of the aforementioned elements comprise or consist of a virtual machine (VM), that VM may constitute a virtualization of any combination of the physical components disclosed in FIG. 12.

In the example of FIG. 12, the physical computing device 1200 includes a memory 1202 which may include one, some, or all, of random access memory (RAM), non-volatile memory (NVM) 1204 such as NVRAM for example, read-only memory (ROM), and persistent memory, one or more hardware processors 1206, non-transitory storage media 1208, UI device 1210, and data storage 1212. One or more of the memory components 1202 of the physical computing device 1200 may take the form of solid state device (SSD) storage. As well, one or more applications 1214 may be provided that comprise instructions executable by one or more hardware processors 1206 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
receiving input from a user;
using the input to identify sources in a RAG (Retrieval Augmented Generation) database;
selecting, from the sources, excerpts with information deemed responsive to the user input;
performing auto-regressive generation of trustworthy content, based on at least some of the excerpts;
post-processing the trustworthy content; and
returning the post-processed trustworthy content to the user.

2. The method as recited in claim 1, wherein each of the excerpts is unique and does not overlap, in terms of content, with any of the other excerpts.

3. The method as recited in claim 1, wherein selection of the excerpts is performed using an LLM (large language model).

4. The method as recited in claim 1, wherein the auto-regressive generation comprises performing extractive decoding, and abstractive decoding, on information in the excerpts.

5. The method as recited in claim 1, wherein the excerpt selection is performed using a content generation prompt that is built based on the input received from the user and on information about the sources.

6. The method as recited in claim 1, wherein the auto-regressive generation is performed using an LLM (large language model).

7. The method as recited in claim 1, wherein the auto-regressive generation comprises switching between extractive decoding, and abstractive decoding, of information in the excerpts.

8. The method as recited in claim 1, wherein the input from the user comprises a query.

9. The method as recited in claim 1, wherein the post-processed trustworthy content is returned to the user by a virtual assistant.

10. The method as recited in claim 1, wherein a deterministic link connects the information with the sources.

11. A non-transitory storage medium having stored therein instructions that are executable by one or more hardware processors to perform operations comprising:
receiving input from a user;
using the input to identify sources in a RAG (Retrieval Augmented Generation) database;
selecting, from the sources, excerpts with information deemed responsive to the user input;
performing auto-regressive generation of trustworthy content, based on at least some of the excerpts;
post-processing the trustworthy content; and
returning the post-processed trustworthy content to the user.

12. The non-transitory storage medium as recited in claim 11, wherein each of the excerpts is unique and does not overlap, in terms of content, with any of the other excerpts.

13. The non-transitory storage medium as recited in claim 11, wherein selection of the excerpts is performed using an LLM (large language model).

14. The non-transitory storage medium as recited in claim 11, wherein the auto-regressive generation comprises performing extractive decoding, and abstractive decoding, on information in the excerpts.

15. The non-transitory storage medium as recited in claim 11, wherein the excerpt selection is performed using a content generation prompt that is built based on the input received from the user and on information about the sources.

16. The non-transitory storage medium as recited in claim 11, wherein the auto-regressive generation is performed using an LLM (large language model).

17. The non-transitory storage medium as recited in claim 11, wherein the auto-regressive generation comprises switching between extractive decoding, and abstractive decoding, of information in the excerpts.

18. The non-transitory storage medium as recited in claim 11, wherein the input from the user comprises a query.

19. The non-transitory storage medium as recited in claim 11, wherein the post-processed trustworthy content is returned to the user by a virtual assistant.

20. The non-transitory storage medium as recited in claim 11, wherein a deterministic link connects the information with the sources.
